(19) United States
(12) Patent Application Publication
(10) Pub. No.: US 2016/0333608 A1
(43) Pub. Date: Nov. 17, 2016

(54) Anti-Bumping Impact Protection Device and Method for Solenoid-Operated Locking Containers

(71) Applicant: Michael Earl Ingle, Thousand Oaks, CA (US)

(72) Inventor: Michael Earl Ingle, Thousand Oaks, CA (US)

(21) Appl. No.: 14/713,355

(22) Filed: May 15, 2015

(51) Int. Cl. E05B 47/02; E05B 65/00

(52) U.S. Cl. CPC E05B 47/026; E05B 65/00

(57) ABSTRACT

Existing small and medium-sized solenoid-operated locking containers are vulnerable to undesired impact-induced opening. An impact-resistant solenoid-operated locking container is disclosed. The container is protected against impact by the use of two solenoids oriented 180 degrees opposite each other. The solenoids are further protected against binding in a retracted position by T-shaped end caps, affixed to their retractable plungers, engaging notches cut into a movable plate. A silent, or nearly silent, impact-resistant solenoid, for use in an impact-protected locking container, is also disclosed, having the motion of its retractable plunger slowed and quieted by a viscous fluid such as damping grease.

### CROSS-REFERENCE TO RELATED APPLICATIONS

None

### STATEMENT REGARDING FEDERALLY SPONSORED RESEARCH AND DEVELOPMENT

Not Applicable

### BACKGROUND

1. Field

The application relates to container locks, and specifically to solenoid-operated container locks which are resistant to unauthorized opening by kinetic impact.

2. Prior Art

U.S. Pat. No. 5,249,831 is an electric lock, having the bolt directly moved by a solenoid, with a counterweight to protect it against impact opening.

U.S. Pat. No. 7,424,814 B2 is a complex dead bolt lock with an inertial device to protect it against impact opening.

U.S. Pat. App. No. 20020011085 is an electric lock equipped with an anti-shock belcrank.

U.S. Pat. App. No. 20100132418 is an electric lock with a lever and counterweight anti-shock mechanism.

There is some prior art, cited above, regarding impact-resistant lock design for electrically operated locking containers. However, none of this prior art is applicable to the most common, inexpensive, and vulnerable electrically operated locking container design: the solenoid-operated locking container with an opening knob. The present device is a simple and inexpensive protection device that can be added to these existing locking container designs to make them highly impact resistant.

### SUMMARY

The vast majority of small and medium-sized electronic locking containers, including firearm safes, use an electromagnetic solenoid and opening knob to release the bolt carriage. This design is simple and inexpensive, does not require high manufacturing tolerances, and easily accommodates a key bypass lock. Small containers with more secure motor-driven mechanisms are less common, and are far more expensive than solenoid-operated containers.

Unfortunately, small and medium-sized solenoid-operated containers are highly vulnerable to unauthorized impact opening, by simply dropping the container a few centimeters and turning the opening knob. At least one fatality has allegedly resulted from a child gaining access to a firearm in this way. There is an urgent need for an improvement to this solenoid-operated design to make it impact resistant.

In a solenoid-operated locking container, the solenoid's retractable plunger normally blocks the sliding motion of a movable plate and attached bolt carriage when someone attempts to turn the opening knob. When the user authenticates, for example by using a code or fingerprint, the electronic controller energizes the solenoid. The plunger retracts, generally less than one centimeter, and the bolt carriage is free to move when the user turns the opening knob. When the solenoid's power is removed, the spring extends the retractable plunger once more.

If the container is “bumped”, or accelerated downward and then abruptly stopped, inertia causes the retractable plunger to continue to move downward. If the opening knob is turned at this moment, the container will open. Due to the combination of the heavy retractable plunger, low return spring constant, and short plunger travel, only a small impact is required to momentarily retract the plunger enough to open the lock. The vulnerable interval is only a fraction of a second, so careful timing is required to use this method, hereafter called the timing vulnerability.

If the opening knob is first turned so that the movable plate lightly contacts the retractable plunger, and the container is then dropped, in many cases the plunger will descend and bind in the refracted position against the movable plate. When this happens, the container can be opened by turning the opening knob further. No skill or timing is required to use this method, hereafter called the binding vulnerability, and children have allegedly performed it accidentally while playing with safes.

One method of preventing the binding vulnerability is to add a T-shaped cap to the end of the retractable plunger, and to cut a corresponding notch into the movable plate. If the plate is moved to contact the plunger, the cap engages the notch to prevent the downward motion of the plunger.

One method of preventing the timing vulnerability is to place a second solenoid above the plate with its retractable plunger facing downward, 180 degrees opposite the first solenoid's retractable plunger. Because the plungers move in opposite directions, an impact which displaces one solenoid's plunger will not affect the other solenoid.

Another method of reducing the motion of an electromagnetic solenoid's retractable plunger when the solenoid is decelerated is to coat the plunger with a velocity-dependent viscous fluid, such as damping grease.

### BRIEF DESCRIPTION OF THE DRAWINGS

A more complete understanding of the present device can be obtained by considering the detailed description in conjunction with the accompanying drawings, in which:

FIG. 1 illustrates the mechanical and electrical components located on the inside panel of the door of an exemplary embodiment of a prior art solenoid-operated locking container, which is not impact protected.

FIG. 2 illustrates the mechanical and electrical components located on the inside panel of the door of an exemplary embodiment of a solenoid-operated locking container, which is impact protected by two opposing electromagnetic solenoids with T-shaped retractable plungers, and corresponding notches cut into its movable plate.

FIG. 3 illustrates the mechanical and electrical components of an exemplary embodiment of an electromagnetic solenoid, the motion of which is slowed by a velocity-dependent viscous fluid, such as damping grease, to prevent impact opening.

### DETAILED DESCRIPTION

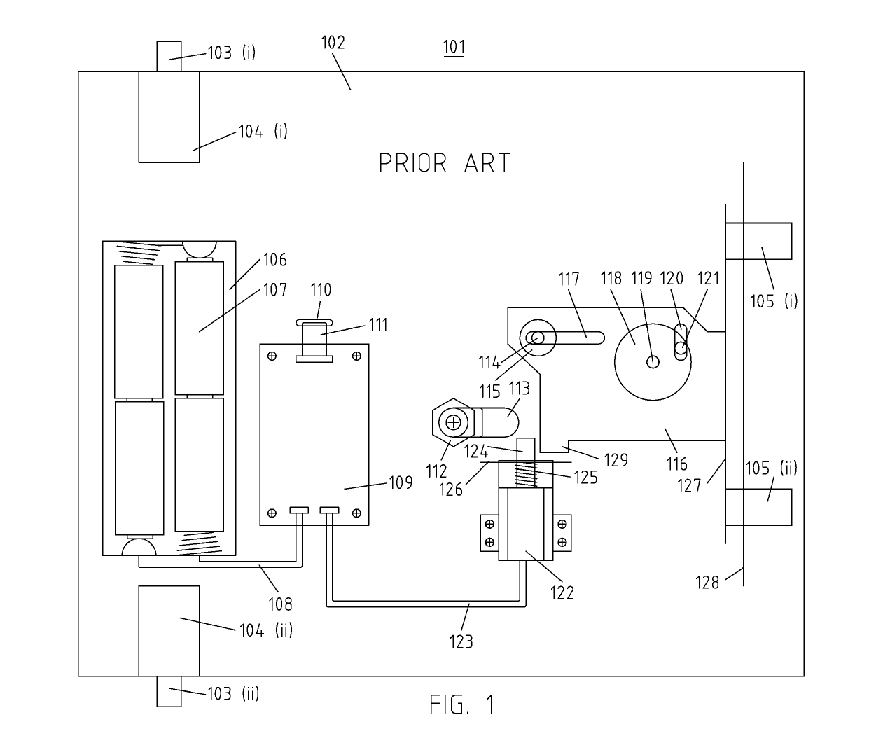

FIG. 1 illustrates the mechanical and electrical components of an exemplary embodiment 101 of a prior art solenoid-operated safe, which is not protected against impact, as seen from the inside of the safe door 102, with its covers removed.

Hinge pins 103 and hinges 104 attach the door to the safe. Locking bolts 105 are affixed to a bolt carriage 127, and pass through holes in a fixed plate 128 attached to the safe body, so that when the door is closed and locking bolts 105 are extended, the door cannot be opened until locking bolts 105 are retracted.

Bolt carriage 127 is affixed at a right angle to movable plate 116. Pin 114 is affixed to the safe door 102 and passes through notch 117 in movable plate 116. Washer 115, affixed to pin 114, holds movable plate 116 parallel to the safe door 102 while leaving it free to slide back and forth, thus moving locking bolts 105.

Shaft 119 extends through a hole in safe door 102 and attaches to the opening knob on the front of the safe, enabling the user to move movable plate 116 from outside the safe. Wheel 118 is affixed to shaft 119. Notch 120 is cut into movable plate 116, and pin 121 is affixed to wheel 118. Therefore, turning wheel 118 counter-clockwise (facing FIG. 1) causes movable plate 116 to move leftward, retracting locking bolts 105, while pin 121 moves upward in notch 120. Turning wheel 118 clockwise causes movable plate 116 to move rightward while pin 121 moves downward in notch 120, extending locking bolts 105.

Tab 129 is part of movable plate 116, and extends downward. Electromagnetic solenoid 122 is affixed to safe door 102. Solenoid 122 has a retractable plunger 124, a return spring 125, and a plate 126. Plate 126 is affixed to retractable plunger 124. Cable 123 connects solenoid 122 to circuit board 109. With locking bolts 105 extended, when a user turns the opening knob and thus wheel 118, in an attempt to retract locking bolts 105, tab 129 is blocked by retractable plunger 124, preventing movable plate 116 from moving, and so preventing locking bolts 105 from retracting.

When the unlocking criteria are met, circuit board 109 energizes solenoid 122, causing retractable plunger 124 to move downward, compressing spring 125. Tab 129 is no longer blocked, and the user can turn the opening knob to retract locking bolts 105. When the current to solenoid 122 is turned off, tab 129 holds down plunger 124 until the opening knob is turned to extend locking bolts 105. Spring 125 then lifts plunger 124, thus blocking tab 129 again and locking the safe.

Bypass lock 112 passes through safe door 102 from the front and is affixed to safe door 102. Bypass lock cam 113 is affixed to the cylinder of bypass lock 112. When the user inserts the correct key and rotates the lock cylinder, bypass lock cam 113 rotates clockwise and presses against plate 126, depressing retractable plunger 124 and permitting the safe to be opened.

Battery holder 106 contains four AA-type alkaline cells 107 in a series circuit. Cable 108 connects battery holder 106 to circuit board 109. Ribbon cable 111 passes through slot 110 cut into door 102, and connects circuit board 109 to the keypad on the front of the door.

This embodiment is commonly used as described. However, it is flawed in that, if the entire safe assembly is accelerated downward and then abruptly stopped, retractable plunger 124's inertia causes it to continue moving downward. There are two distinct vulnerabilities created by this.

In the timing vulnerability, tab 129 is not in contact with retractable plunger 124 when the safe is impacted. Wheel 118 must be manually turned using the opening knob during the fraction of a second while plunger 124 is below the bottom of tab 129. In practice, this is not difficult to accomplish, and after a few attempts, many people can open the safe using the timing vulnerability. All safes of the design shown in FIG. 1 are vulnerable to the timing vulnerability.

In the binding vulnerability, turning the opening knob moves tab 129 into light contact with retractable plunger 124, causing plunger 124 to tilt slightly leftward inside solenoid 122. If the safe is now impacted, plunger 124 will descend below tab 129 and return to its vertical orientation while compressing spring 125. Spring 125 then causes plunger 124 to rebound. Plunger 124 contacts the bottom of tab 129 and stops. The safe can then be opened by further turning the opening knob. Not all solenoid-operated safes are vulnerable to the binding vulnerability, but no skill or timing is required to exploit this flaw. Children have allegedly opened safes accidentally while playing with them.

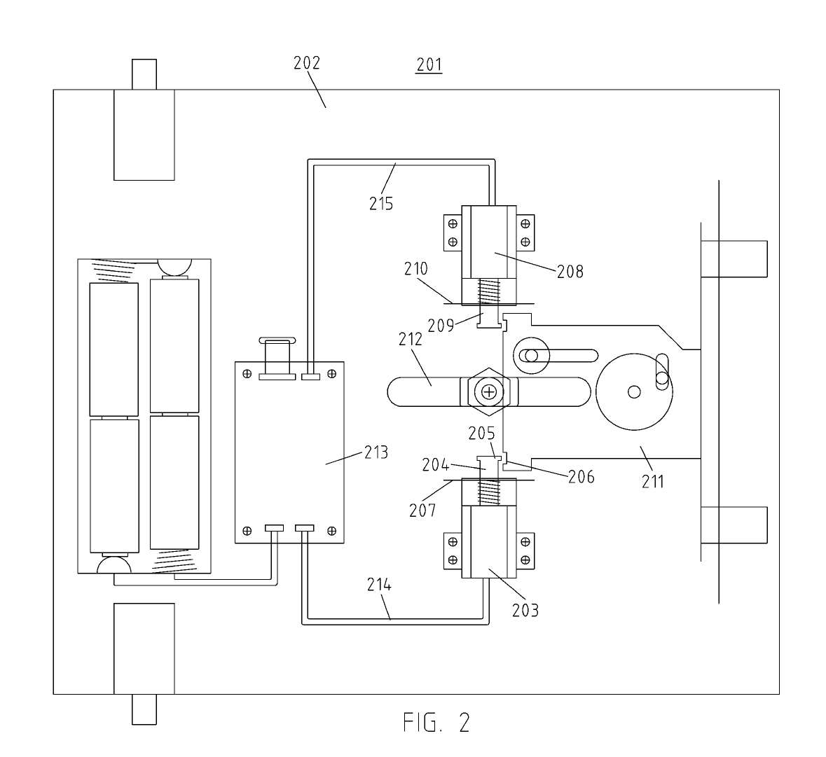

FIG. 2 illustrates an exemplary embodiment of a solenoid-operated locking container 201, which is protected against both the binding and timing vulnerabilities. Electromagnetic solenoid 203 has been modified, in that retractable plunger 204 has a T-shaped end cap 205. A corresponding notch 206 has been cut into movable plate 211. If movable plate 211 is moved into contact with plunger 204, T-shaped end cap 205 engages notch 206 and prevents plunger 204 from descending when the safe is impacted. This protects against the binding vulnerability.

Electromagnetic solenoid 208 is identical to solenoid 203 and is placed at a 180-degree angle to solenoid 203. Cables 214 and 215 connect solenoids 203 and 208 to circuit board 213. Both solenoids are energized simultaneously by circuit board 213 when the safe is electrically unlocked. Bypass lock cam 212 has two lobes, so when it is turned clockwise, the left side of bypass lock cam 212 presses against plate 210, and the right side of bypass lock cam 212 presses against plate 207, depressing both retractable plungers 204 and 209, and permitting movable plate 211 to pass.

If the safe is accelerated downward and then abruptly stopped, plunger 204 will move downward, while plunger 209 will continue to block movable plate 211's motion. If the safe is accelerated upward and then abruptly stopped, plunger 209 will move upward while plunger 204 will continue to block movable plate 211's motion. Since solenoids 203 and 208 are placed opposite each other, no impact will retract both plungers 204 and 209 simultaneously. This protects against the timing vulnerability.

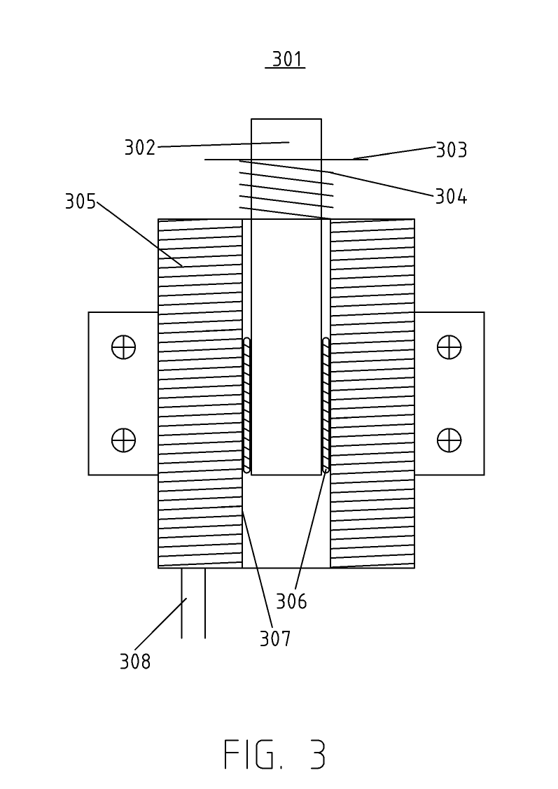

FIG. 3 shows the mechanical and electrical components of an exemplary embodiment 301 of an electromagnetic solenoid which is internally protected against impact. Solenoid 301 has a retractable plunger 302. Plate 303 is affixed to plunger 302, and compresses spring 304 when the solenoid coil 305 is energized via cable 308.

Solenoid 301's retractable plunger 302 is removed and coated with a viscous fluid 306, such as Nye Lubricants Fluorocarbon Gel #868 Damping Grease. When plunger 302 is replaced in solenoid 301, some of fluid 306 will transfer to inner wall 307 of the solenoid body, forming a bead between inner wall 307 and retractable plunger 302.

It is also possible to apply viscous fluid 306 directly to inner wall 307, or to both inner wall 307 and retractable plunger 302. Coating plunger 302 is the easiest method.

Viscous fluids such as damping grease are available in a range of viscosity grades, and the appropriate grade must be chosen based on the spring constant of spring 304. A stronger spring 304, combined with higher viscosity fluid 306, provides greater impact resistance, but requires more electrical power to retract plunger 302.

When solenoid coil 305 is energized, viscous fluid 306 provides velocity-dependent dynamic friction between inner wall 307 and retractable plunger 302, slowing the downward motion of plunger 302 without stopping it. Similarly, when solenoid coil 305 is turned off, viscous fluid 306 slows the upward motion of plunger 302.

If fluid-damped solenoid 301 is accelerated rapidly upward, viscous fluid 306 produces a high degree of velocity-dependent dynamic friction, preventing retractable plunger 302 from fully retracting. In this way, solenoid 301's vulnerability to impact opening is reduced, compared to a solenoid without fluid damping. Solenoid 301 can be used alone, or in an upper and lower solenoid pair for maximum impact protection.

Fluid-damped solenoid 301 has the further advantage of being silent or nearly silent in operation. A solenoid-operated locking mechanism is often used in firearm storage containers intended to be opened while an intruder is present in the house. The click of an undamped solenoid could alert the intruder to the user's location, while a silent operating mechanism would provide a tactical advantage for the user.

### CONCLUSION

The foregoing Detailed Description has disclosed, to those skilled in the field of mechanical engineering, how to construct a solenoid-operated locking container which is protected against impact-induced opening, and which can be unlocked by either electric current or a backup key. The opposed solenoids with T-shaped end cap and notch embodiment, and the viscous fluid embodiment, can be used together or separately.

For the foregoing reasons, the Detailed Description is to be regarded as being in all respects exemplary and not restrictive, and the breadth of the device and method disclosed herein is to be determined not from the Detailed Description, but rather from the claims, as interpreted with the full breadth permitted by the patent laws.

What is claimed is:

1. A locking mechanism suitable for containers, comprising:
(a) a container having a door,
(b) a movable plate, affixed to the inside of said door,
(c) locking bolts, affixed to said movable plate,
(d) driving means, for moving said movable plate from outside said container,
(e) an electromagnetic solenoid, affixed to the inside of said door, having a retractable plunger capable of blocking the motion of said movable plate,
(f) restrictive means, for reducing the impact-induced motion of said retractable plunger,
whereby said locking bolts may be released by an electric current applied to said electromagnetic solenoid, and whereby said locking bolts are prevented from being released when external impact is applied to said container.

2. The device of claim 1, wherein said restrictive means comprises:
(a) a T-shaped end cap, affixed to said retractable plunger,
(b) a notch, cut into said movable plate, aligned with said T-shaped end cap,
whereby said retractable plunger is prevented from retracting, when an impact is applied, and while in contact with said movable plate.

3. The device of claim 1, wherein said restrictive means comprises viscous fluid coating said retractable plunger, forming a bead between said retractable plunger and an inner wall of said electromagnetic solenoid.

4. The device of claim 1, wherein a second electromagnetic solenoid is affixed to the inside of said door, oriented 180 degrees opposite said electromagnetic solenoid, and having a second retractable plunger capable of blocking the motion of said movable plate.

5. The device of claim 4, wherein said restrictive means comprises:
(a) a T-shaped end cap, affixed to said retractable plunger,
(b) a notch, cut into said movable plate, aligned with said T-shaped end cap,
(c) a second T-shaped end cap, affixed to said second retractable plunger,
(d) a second notch, cut into said movable plate, aligned with said second T-shaped end cap.

6. A method of reducing undesired impact-induced retraction of an electromagnetic solenoid's retractable plunger, comprising:
(a) removing said retractable plunger from said electromagnetic solenoid,
(b) coating said retractable plunger with a viscous fluid,
(c) placing said retractable plunger into said electromagnetic solenoid,
whereby said viscous fluid forms a bead between said retractable plunger and an inner wall of said electromagnetic solenoid, and whereby said bead reduces the impact-induced refraction of said retractable plunger.

7. A method of reducing undesired impact-induced retraction of an electromagnetic solenoid's retractable plunger, comprising:
(a) removing said retractable plunger from said electromagnetic solenoid,
(b) coating an inner wall of said electromagnetic solenoid with a viscous fluid,
(c) placing said retractable plunger into said electromagnetic solenoid,
whereby said viscous fluid forms a bead between said retractable plunger and said inner wall of said electromagnetic solenoid, and whereby said bead reduces the impact-induced refraction of said retractable plunger.
